(19) United States
(12) Patent Application Publication
(10) Pub. No.: US 2017/0249663 A1
(43) Pub. Date: Aug. 31, 2017

(54) METHOD OF TARGETING WEB-BASED ADVERTISEMENTS

(71) Applicant: REALEYES OÜ, Tallinn Harju (EE)

(72) Inventors: Elnar HAJIYEV, Morden (GB); Martin SALO, London (GB)

(21) Appl. No.: 15/506,652

(22) PCT Filed: Sep. 1, 2015
(86) PCT No.: PCT/EP2015/069908

§ 371 Date: Feb. 24, 2017

(30) Foreign Application Priority Data
Sep. 1, 2014 (GB) 1415428.0

(51) Int. Cl. G06Q 30/02

(52) U.S. Cl. CPC G06Q 30/0254; G06Q 30/0269; G06Q 30/0275; G06Q 30/0255; G06Q 30/0277

(57) ABSTRACT

Embodiments of the invention provide a computer-implemented method of participating in a web-based content provision process, e.g. an ad-bidding process for proposing an ad to serve for an ad impression. The method can include recording physical behavioural information, e.g. emotional state, attentiveness, gaze tracking, etc., to infer or further refine a user profile for a user or to establish or further refine a target profile for a piece of media content, e.g. an advertisement. A quantitative indicator can be obtained by comparing user profiles with target profiles, which can be used to automate the content provision process. The process can use a plurality of preset user types and a plurality of preset ad target types, whereby each user is allocated to one or more of the preset user types and each ad is allocated to one or more of the preset ad types.

### FIELD OF THE INVENTION

The invention relates to the targeting of web-based advertisements, referred to herein as ads. In particular, the invention relates to the processing and analysis of user behavioural (e.g., emotional) data detected for a user for the purpose of enhancing the provision of web advertising, which may take place in conjunction with a real-time bidding process. The use of such processing and analysis allows systems utilized by advertisement producers, distributors, network operators and similar entities to be responsive to such processing and analytics so as to limit transmission of certain advertising content to only those users that express a behavioural interest in receiving such advertisements, thereby conserving network and computational resources.

### BACKGROUND TO THE INVENTION

It is well known to provide web-based systems for recommending content on the basis of historical data relating to a user, e.g., his or her purchase or browsing history. Often, a given user has an associated profile that is operative to store this information.

Online advertising comprises a large part of the display and video advertising market. In common with all types of advertising, it is desirable to limit or otherwise restrict the display of a web-based advertisement (also referred to herein as an ad) to relevant consumers, both in order to maximise the influence of the ad, as well as the advertiser's return on investment.

Digital advertising supply systems, such as online advertising networks, demand side platforms, supply side platforms, real-time bidding platforms, etc., provide an interconnection between advertisers seeking to serve their content to prospective consumers and website hosts willing to display such content in the form of ads. The website hosts provide web-based advertising inventory, which can be filled by advertiser's content. Advertising inventory can take many forms, including space on a website, e.g., a side banner, pop-up windows, slots for video media, etc.

Advertisers have explored a programmatic approach to buying advertising inventory, e.g., systems in which computational logic, such as rules, algorithms, etc., is used to automate the purchase of advertising inventory and targeting of ads. Programmatic buying is applicable across all types of digital ad supply systems. For example, targeted advertising networks are a type of online advertising network that aims to serve ads more effectively by using information about a user and/or the context associated with any given piece of web-based advertising inventory. Using an exemplary targeted advertising network, a user's browsing history (e.g., in the form of the clickstream) can be used to generate a user profile. Advertisers may seek to automate the display of their ads to users whose profiles are relevant to the ad or to the intended market.

Often times used in conjunction with a programmatic approach to buying advertising inventory, it is known to partition an audience into a very large number (e.g. 10,000 or more) of segments. The segments can be distinguished from one another based on a wide variety of user attributes, e.g., demographics, context, psychographics, purchase history, brand affinity and browsing activity. The segment to which a given user belongs can be updated in real time.

Also used in conjunction with a programmatic approach to buying advertising inventory, real-time bidding comprises the auction of advertising inventory, which can be bought and sold on a “per impression” basis. Herein, an impression corresponds to an ad request that is triggered by a user accessing certain web content, e.g., on a video-sharing or social media website. An ad impression can thus carry with it information about the user that has triggered it. Advertising inventory is the advertising real estate itself—the “space” associated with the web content in which the ad is displayed.

### SUMMARY OF THE INVENTION

At its most general, embodiments of the present invention propose using recorded physical behavioural information, e.g., emotional state, attentiveness, gaze tracking, etc., either to infer, establish or further refine a user profile for a user or to infer, establish or further refine a target profile for a piece of media content. In particular embodiments, such inference, establishment or refinement is in relation to an ad target profile for an ad.

As used herein, a user profile can be an association between an individual consumer of web-based content and one of a plurality of audience segments. A given audience segment can have a plurality of attributes associated with it, including for example demographic information, psychographic information, etc. The attributes can further include behavioural information, e.g., information associating positive and/or negative emotional states with certain types of content.

Beyond use in a user profile, the recorded physical behavioural information can be used to give a real time indication of a current mood of the user. This information can be used either alone or in conjunction with the user profile to determine how an advertiser responds to (e.g., places a bid on) an available ad impression involving that user.

An target profile for a piece of media content, which may be an advertisement, is a data structure that identifies properties of a target user, in other words, the properties of a consumer who is more likely to lead to the ad achieving its goal. Ad campaigns can identify many different types of goals or desired “action”, e.g., from inspiring a booking to simply raising brand awareness. In general advertisers seek to reduce the cost per action, or cost per view. Thus, a scheme that enables an ad target profile to be matched with a corresponding consumer can maximise the probability that an action occurs, thereby reducing the cost per action.

According to embodiments of the invention, recorded physical behavioural information can be used to improve the matching between an ad target profile and a user profile (audience segment) by providing another dimension in which comparisons can be made.

In certain circumstances, it may not be computationally efficient to have a profile for each ad and for each user. Accordingly, embodiments of the invention can operate using a plurality of preset user types (e.g., corresponding to a plurality of predetermined audience segments) and a plurality of preset ad target types (e.g., corresponding to a plurality of predetermined target consumers). A given user can thus be allocated to one or more of the user types and a given ad can be allocated to one or more of the ad types.

According to one embodiment, such an allocation can be achieved by hardware and software deployed by an advertiser, ad network, or similar third party, comprising a processor executing program code to generate a user profile metric for a given user, which associates a probability value with a user to represent the probability that the user falls within a given preset user type. The recorded behavioural information for the user can be used to update or refine the probability values.

An ad target profile metric, which can be generated for a given ad, can associate a weighting value with each preset ad target type to represent the weight with which that ad is aimed at that preset ad target type. As behavioural information is collected for the ad, the weighting values can be adjusted to take into account how the ad is being received. For example, if the ad results in unexpectedly high action levels for certain user types, program code can instruct the processor to increase the weighting value for those user types associated with the ad in order to quantify the increased chances of the ad successfully achieving its objective for those user types.

In determining how to bid on an ad impression, an advertiser can take various factors into account. Various embodiments of the present invention seek to provide an additional parameter for this process, which is a quantitative indicator that can be used by the processor, in executing instructions stored as program code, to represent the probability that an action will result from serving a given ad to a given user.

In order to establish such a quantitative indicator, embodiments of the invention can provide, e.g., in a profiling server, an action probability matrix which stores an action probability for various combinations of preset ad target types and preset user types. In combination with a given user profile metric for a specific user, the processor can execute program code to use the action probability matrix to determine a preferred ad type or a set of preferred ad types to be served.

According certain embodiments, if the user profile metric is expressed as a column vector u, the action probability matrix as M, and the ad target profile metric as a row vector α, the result of the matrix multiplication αMu is a scalar number whose value represents the scale of the match between the user and the ad; the higher the number the better the match. Program code that the processor executes can use this value to score a plurality of available ads. The advertiser can determine a bid (e.g., select an ad and select a bid price) based on the scores received for a plurality of available ads.

Thus, according to one embodiment of the invention, there is provided a computer-implemented method of participating in an web-based ad bidding process, the method comprising: receiving, e.g., in a bidding engine or in an ad network from an ad exchange, notification of an ad impression, the notification comprising a user identifier associated with a user of a remote client device on which the ad impression is located; selecting a candidate ad for the ad impression; sending the user identifier and an ad identifier associated with the candidate ad to an evaluation engine; obtaining a user profile associated with the user identifier; obtaining an ad target profile associated with the ad identifier; comparing the user profile with the ad target profile to generate a quantitative indicator of the similarity between the user profile and the ad target profile; returning the quantitative indicator; and determining, based on the quantitative indicator, a bid for the candidate ad in response to the ad impression, wherein the user profile is indicative of the user's behavioural characteristics, and wherein the ad target profile is indicative of a target user's desired behavioural characteristics.

The user identifier can be a page tag transmitted in any conventional format, e.g. as an embedded image (i.e. tracking pixel) or cookie or JavaScript tag sent with the ad request.

The invention thus provides an extra dimension of behavioural information to the process of deciding how to bid for an ad impression. Advantageously, the behavioural information is provided on both sides of the comparison, relating both to actual behavioural characteristics recorded for a user and to desired behavioural characteristics associated with a notional target user.

The evaluation engine can be an integral part of a decision engine, e.g., bidding engine, at an advertiser or on an ad network. The evaluation engine can be embodied as executable code stored on a server and executed by a processor at the server, which receives the user identifier and the ad identifier. The processor executing evaluation engine program code can repeatedly generate the quantitative indicator for a plurality of ads belonging to a given advertiser. A bid can be made for one or more of the plurality of ads. In this embodiment, the advertiser has direct access to the user profile and ad target profile information.

In accordance with alternative embodiments, however, program code implementing the evaluation engine can be executed by a one or more processors that are part of third party servers, e.g., on a server that is separate or otherwise remote from an ad network or bidding engine. In this embodiment the user profiles and ad target profiles are stored and maintained by the third party and are not accessible by the advertisers. Instead, a processor executing program code that implements the evaluation engine at the third party provides the advertisers with a quantitative indicator in response to a request containing a user identifier and ad identifier.

Herein, “behavioural characteristics” includes, but is not limited to, the emotional state data of a given user, e.g., emotions detected from facial expressions and other physiological indicators that can be captured via a webcam. Additionally, the behavioural data can include other information that can be collected from a user that interacts with media content, e.g., any of gestures, blood pressure (e.g., based on skin colour), temperature, blinking, heart rate (e.g., read visually by slight changes of skin colour), etc.

Behavioural data according to certain embodiments can also include data concerning the user's interaction with the computer, e.g., audio data, click data or other data indicative of the user's interest in a portion of the display. In addition to behavioural data, embodiments of the invention can also provide for the collection and transmission of other user data, e.g., data indicative of other details about the user, such as gender, age, location, etc.

To aid meaningful comparison, program code is provided according to certain embodiments that instructs the processor to derive the behavioural characteristics of the user from time series behavioural data recorded for that user. The desired behavioural characteristics of the ad target can be derived from aggregated behavioural data recorded for a plurality of users who have previously been exposed to the ad.

The behavioural characteristics can comprise average properties for one or more emotions captured for the user or plurality of users while exposed to a range of media content. Alternatively, or additionally, behavioural characteristics can be inferred for the user based on recorded behavioural data for the user associated with one or more known pieces of media.

The emotions for which data is collected can include, but are not limited to, angry, disgusted, neutral, sad, scared, happy, surprised and their derivatives. Other behavioural information (e.g., physical data such as head orientation or upper body posture) can also be collected. This other behavioural information can be combined with emotion state information to derive further indicators of a computer user's reaction, e.g., engagement, disinterest, etc.

Utilizing behavioural data for ad selection or targeting provides numerous benefits to the operation of networked computing devices—as such, targeting allows for the more efficient use of such computing resources, especially finite bandwidth that may be unnecessarily consumed when transmitting unwanted ads, which may in turn have an adverse impact on device performance.

In accordance with various embodiments of the invention, the client device can include a data collection module in which program code instructs a processor to process the collected facial image, or transmit the collected facial images to a remote analysis server for processing. The data can be sent as a video stream or as a series of (e.g., images periodically extracted from a video stream) images.

Data collected by the data collection module, which may reside at the analysis server or the client device, can be arranged for processing of the images to generate data representative of one or more emotional states. For example, the analysis can generate a metric for each of six universal emotions, e.g., happiness, sadness, surprise, fear, disgust and anger. The analysis can also generate one or more further metrics that can be independent of the emotions or based on other combinations of facial feature movement. For example, the further metrics can include, but are not limited to, engagement, attentiveness, boredom, confusion, neutrality and valence. Any one or any combination of the metrics can be used as behavioural characteristics in the present invention.

The method according to embodiments of the invention can further comprise receiving, e.g., in the ad exchange, a plurality of bids for candidate ads in response to the ad impression; determining, e.g., in the ad exchange, a successful bid from the plurality of bids; and serving advertising content corresponding to the successful bid over the web to the remote client device in satisfaction of the impression. Thus, a plurality of different advertisers can each provide whichever of their ads is a best fit or match with the ad impression.

The step of comparing the user profile with the ad target profile can comprise determining a level of correlation between the user's behavioural characteristics and a target user's desired behavioural characteristics, wherein the quantitative indicator is based on the determined level of correlation.

The user profile can associate the user with one or more of a plurality of preset user types, wherein each preset user type comprises a combination of behavioural characteristics. For example, according to one embodiment the user profile can comprise a user profile metric, which is a data structure that stores a probability value for the user against each of a plurality of preset user types.

Similarly, the ad target profile can associate a given ad with one or more of a plurality of preset ad target types, wherein each preset ad target type includes a combination of behavioural characteristics. For example, according to one embodiment the ad target profile comprises an ad target profile metric, which is a data structure that stores a weighting value for the ad against each of a plurality of preset ad target types.

The method according to certain embodiments includes obtaining or maintaining a user-target correlation matrix, which is a data structure that stores an action probability index value against combinations of preset user types from the plurality of preset user types and preset ad target types from the plurality of preset ad target types. The action probability index value is a parameter that quantifies the probability of achieving a desired action in respect of a given ad target type for a given user type. The matrix can be used in the step of comparing the user profile with the ad target profile, e.g., to calculate a correlation index for each combination of a preset user type from the plurality of preset user types and a preset ad target type from the plurality of present ad target types. A given user may have a user probability value associated with each of the plurality of preset user types. The user probability value can be indicative of how closely the user matches a given preset user type. A given ad may have an ad probability value associated with each of the plurality of preset ad target types. The ad probability value can be indicative of how closely the ad target matches a given present ad target type. The correlation index can be calculated using the action probability index value, user probability value and ad probability value for each combination of preset user type and preset ad target type. The correlation index can be the product of these three parameters for each combination. The user probability value and the ad probability value can act as a weighting factor for each combination.

Program code executing at the processor can instruct the processor to base the quantitative indicator on the calculated correlation indices. The correlation index of each combination of preset user types from the plurality of preset user types and preset ad target types from the plurality of present ad target types can be the product of the user probability value, action probability index value and ad probability value for that combination. The quantitative indicator can be represented according to certain embodiments by a sum of the correlation indices.

Program code executing can instruct the processor to utilize the correlation index value as being indicative of the probability that presentation of the ad will result in a successful action. The method can comprise collecting data indicative of a successful action following an ad impression, e.g., a click through, purchase or the like. The processor, under control of executing program code, can use this data to update the user-target correlation matrix.

The preset ad target types and/or the preset user types can be manually set, e.g., the distinguishing parameters can be determined by an operator, either in advance, in real-time, or combinations thereof. In accordance with certain embodiments, the preset ad target types and/or the preset user types are determined on the fly using a suitable unsupervised machine learning process, e.g., using a support vector machine, clustering analysis algorithm or the like.

The evaluation engine can be deployed as program code executing on hardware that the advertiser operates. If so, the step of comparing the user profile with the ad target profile can be performed by a processor that is part of the advertiser hardware and executes program code implementing a neural network that has as its cost function the minimum bid price for an ad to succeed in achieving its objective. In this embodiment, the user profile and ad target profile can provide a system of interconnected neurons upon which the model is based.

Methods in accordance with various embodiments of the invention can be incorporated into the known processing performed by ad exchanges. For example, the step of determining, in the ad exchange, a successful bid from the plurality of bids occurs as part of a real-time bidding process.

The method according to certain embodiments can further comprise determining a current emotional state for the user from recorded behavioural data. As such, the method can comprise using the determined current emotional state together with the quantitative indicator to determine the bid for a candidate ad in response to an ad impression. For example, if the current emotional state is negative, the method can determine not to serve any ads, even if the quantitative indicator is favourable, e.g., exceeds a threshold value.

The method according to certain embodiments can further comprise: displaying, on the client device, the advertising content corresponding to the successful bid (also referred to herein as the “successful ad”) in response to the ad request; and collecting behavioural data of the user from the client device while the user is viewing the successful ad.

The collected behavioural data can be used to refine the user profile. For example, the collected data can be used to alter one or more of the plurality of preset user types that are associated with the user or to adjust one or more of the probability values stored in the user profile metric.

Similarly, aggregated behavioural data collected from a plurality of users can be used to refine the ad target profile. For example, the collected data can be used to alter one or more of the plurality of preset ad target types that are associated with the successful ad, or to adjust one or more of the weighting values stored in the ad target profile metric.

Systems and methods in accordance with the various embodiments of the invention can be used to enhance existing real time bidding techniques. Such enhancement may come, for example, by providing an additional dimension (e.g., that of emotional state information) of comparison between users and available ads. By providing such additional dimension, available ads can be properly targeted to users, thereby maximizing network resource utilization in the transmission and processing of such ads and behavioural information.

In another example, the recorded behavioural data from a user who has viewed a successful ad can be used to automatically allocate a rating to the successful ad, e.g., based on whether the user's emotional response was positive or negative, thereby providing an automated mechanism to build out additional metadata regarding a given item of media content.

More generally, embodiments of the invention can be used by advertisers as a technique for optimising media placement decisions, for example, through incorporation into a demand side platform arranged to manage the interaction between a plurality of advertisers and a plurality of inventory sources, e.g., web pages or the like. Again, such optimization allows for the more efficient utilization of network resources, e.g., through elimination of the transmission of ads or other media content that is known (or predicted) to receive an unfavourable response.

In another aspect, one embodiment of the invention can be expressed as a computer-implemented method of selecting a web-based ad, the method comprising: receiving notification of an ad impression, the notification including a user identifier associated with a user of a remote client device on which the ad impression is located; selecting a plurality of candidate ads for the ad impression; sending the user identifier and an ad identifier associated with each of the plurality of candidate ads to an evaluation engine; obtaining a user profile associated with the user identifier; obtaining an ad target profile associated with each ad identifier; comparing the user profile with each ad target profile to generate a plurality of quantitative indicators of the similarity between the user profile and each ad target profile; selecting, based on the quantitative indicator, an ad from the plurality of candidate ads to serve in response to the ad impression; and serving the selected ad. Features described above in relation to the first aspect can also be applied in this aspect.

These and other aspects, features, and embodiments will be more fully appreciated from the accompanying detailed description of certain embodiments of the invention.

### BRIEF DESCRIPTION OF THE DRAWINGS

Embodiments of the invention are discussed below in detail with reference to the accompanying drawings, in which:

FIG. 1 is a schematic diagram of an ad serving system in accordance with one embodiment of the present invention;

FIG. 2 is a flow diagram of an behavioural data collection method in accordance with one embodiment of the invention;

FIG. 3 is a flow diagram of an ad target profile setting method in accordance with one embodiment of the invention;

FIG. 4 is a schematic view of an ad target profile metric that can be used in conjunction with various embodiments of the present invention;

FIG. 5 is a flow diagram of a user profile setting method in accordance with one embodiment of the invention;

FIG. 6 is a schematic view of a user profile metric that can be used in conjunction with various embodiments of the present invention; and

FIG. 7 is a schematic view of an action probability matrix that can be used in conjunction with various embodiments of the present invention.

### DETAILED DESCRIPTION OF CERTAIN EMBODIMENTS OF THE INVENTION

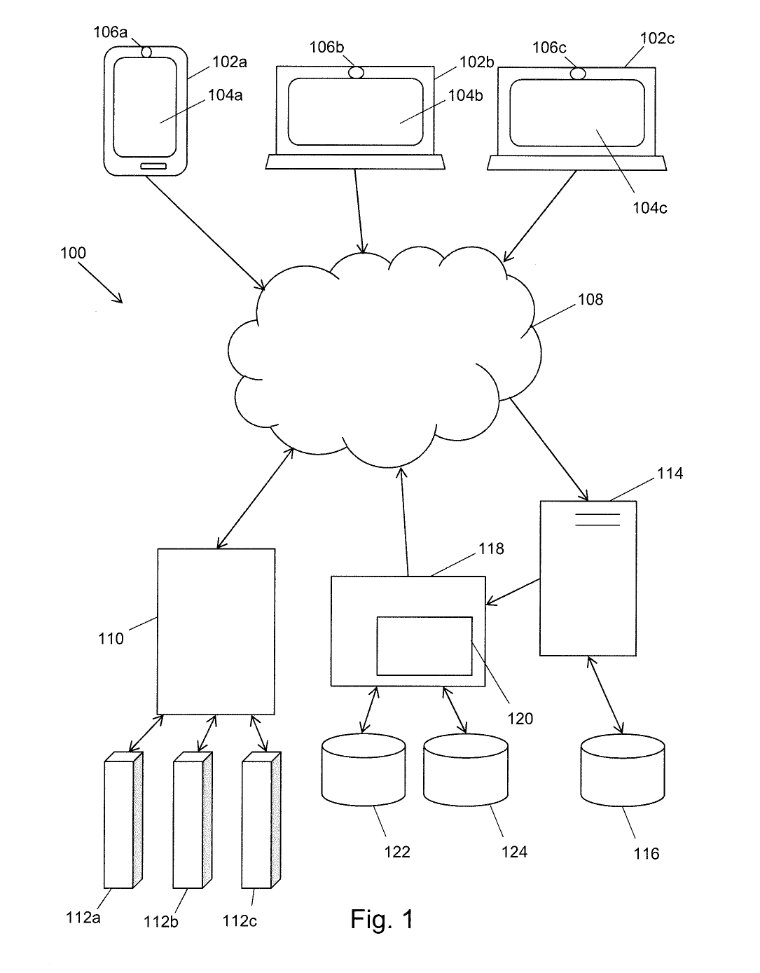

FIG. 1 shows an ad serving system 100 that is an embodiment of the invention, and within which embodiments of the methods of the invention explained below can be executed. The ad serving system 100 comprises a plurality of client devices 102. The client devices 102a, 102b and 102c can be any web-enabled device, e.g., desktop computer, laptop computer, tablet computer, smartphone, etc. Each client device 102 a, 102b and 102c has a respective display screen 104a, 104b and 104c and camera 106a, 106b and 106c (e.g. webcam) capable of capturing images of a user during a user's interaction with the device. The client devices 102a, 102b and 102c are connected to a network, e.g., the World Wide Web 108, through which they can receive web content and interact with remote devices.

The ad serving system 100 further comprises an ad exchange 110, which acts as an intermediary between the client devices 102a, 102b and 102c and a plurality of advertisers 112a, 112b and 112c. The structure of the ad exchange is conventional and well known to those of ordinary skill in the art.

The ad serving system 100 comprises a behavioural data collection server 114. A processor at the behavioural data collection server 114 executes program code that allows for the receipt of client collected or captured behavioural data from the client devices 102a, 102b and 102c via the World Wide Web 108. The behavioural data can represent emotion state data for the user interacting with the client device 102a, 102b and 102c. For example, program code executing at the behavioural data collection server 114 can instruct the processor to receive webcam pictures of the user interacting with the client device. The webcam pictures can be analysed to generate emotion state information, as is known to one of ordinary skill in the art. Alternatively, the webcam pictures can be analysed (or partly analysed) on the client devices themselves. Thus, the information passed to the behavioural data collection server 114 can be partly or wholly analysed.

Herein, the terms “server” and “network-enabled computing device” (or “computing device”) are used to mean a computer having at least one processor that executes instructions therein received from a memory store (e.g., RAM) in order to implement functionality useful in connection with one or more embodiments of the invention. These devices further include network interface components comprising hardware configured to enable communications over a network between the server and between one and a plurality of computing devices at which computer user behavioural data is being captured. By way of example and not limitation, the communications can comprise data packets constructed in accordance with a user datagram protocol (UDP) or an Internet protocol (IP). These devices have hardware or software from an accessible memory which execute in respective processors in order to implement the functionality described herein. As such, more general statements described herein regarding the arrangement of an application, steps taken in connection with one or more methods, functions, capabilities, and so on, unless expressly noted otherwise, are all made in relation to servers and/or computing devices configured by code executing a processor.

The behavioural data collection server 114 can receive behavioural data from a plurality of client devices. For instance, software (which comprises instructions executing in the processor of the computing device) can be used to set up such communication. In the present embodiment, the received behavioural data is used in three ways.

Firstly, the behavioural data from a plurality of users interacting with the same piece of web content (e.g., the same ad) can be aggregated and stored in aggregated data storage 116. Thus, the emotional state responses to viewing the web content from different types of users are collected.

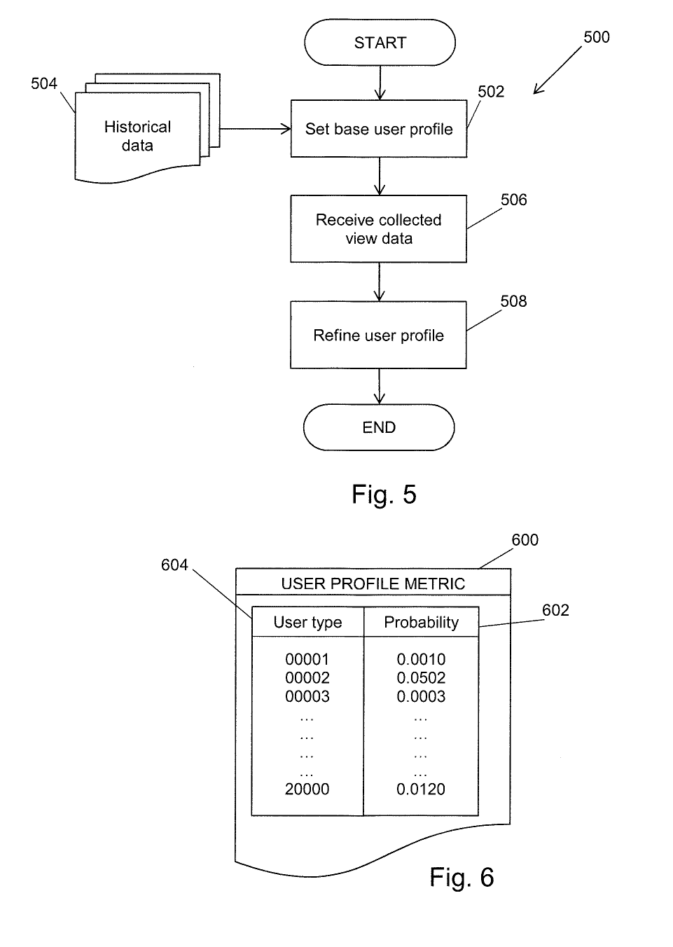

Secondly, the behavioural data is used to establish or refine a user profile for the particular user. One embodiment of a method of performing this task is described below with reference to FIG. 5. Herein, establishing or refining a user profile can mean associating the user with or allocating the user in or selecting for the user a predetermined audience segment from a plurality of predetermined audience segments. As discussed below, any one of these steps can be achieved by altering a user profile metric, which can store a probability value for a respective user against each of the plurality of predetermined audience segments. Program code executing at the server 114 can instruct the processor to update the probability values based on the received behavioural data for a user.

Thirdly, the behavioural data is used to update or refine an ad target profile. Where appropriate, the recorded behavioural data for the user can include or be accompanied by information indicative of satisfaction of an action (e.g., advertising goal) associated with the web content. For example, the goal can be to establish a positive emotional reaction to a brand, or to achieve a certain physical reaction (e.g., a click through).

The user's emotions can be tracked using code that configures the processor of the local computer to make determinations of the computer user's emotions, such as the six universal emotions mentioned herein. Alternatively, the user's emotions can be tracked using code executing at a remote server that configures the processor of the that server to make determinations of the computer user's emotions, such as the six universal emotions described herein, either using the raw captured image data, or, more preferably, using the signals processed by the local computer prior to transmission to any remote server.

The processing of the collected behavioural data may include several sub-processing steps, at least one which transforms the interactive data that has been collected into data packets suitable for transmission to a remote server, and more preferably to include temporal information related to the video playback and the moment or segment that was being played at the client computer during the collection of the computer user behavioural data.

The collected data can undergo additional processing, before transformation into packets or a file for transmission over a network, in order to coordinate the captured computer user behavioural data with moments or segments of the video provided to the computing device during media playback, including at least moments or segments during media playback of a video ad at the computing device. Such processing includes instructions executing in the processor of the computing device which synchronize the images being captured to a temporal location within the media being played back at the user's computing device, such as by associating a time code or range of time codes of the video with the captured computer user behavioural data. The synchronization can be important to solve latency problems associated with the reception of streamed content at the computing device, associated with local processes (such as those which might change the timing of media playback relative to the transmission of streamed content to the computing device), and events at the computing device which also can affect the time window of media playback (e.g., as one non-limiting example, the user pauses or rewinds playback).

The additional processing in accordance with this aspect of the invention causes temporal information concerning the computer user behavioural data to be included among the data packets being transmitted to the remote server, in addition to the transmission of the computer user behavioural data itself.

In further more particularized aspects, the time codes for the moments or segments during which computer user behavioural data is being captured can comprise time offsets relative to a video ad, and optionally relative to other video content being played back in the media playback application.

In still further aspects of the invention, the computing devices can be configured to more efficiently utilize their resources so as to minimize interruption of media during playback. In this regard, system components are monitored and their performance or values are utilized in determinations as to when certain local processing is to be performed. As such, processing of computer user behavioural data can be performed dynamically (starting and stopping) in view of the performance capabilities of the user's computing device on which the processing is being performed and in further view of connectivity between the computing device and the network to which it is connected.

The second and third functions described above can be performed by program code executing at a profiling server 118 that is communicably connected to the behavioural data collection server 114. There can be a plurality of profiling servers, e.g., a first profiling server for updating a user profile, and a second profiling server for updating an ad target profile, or multiple profiling severs working in parallel under the control of a load balancer (not pictured) that passes out active tasks to a given one or more of such multiple profiling servers. Alternatively, as shown in FIG. 1, there can be a single profiling server. The profiling server 118 can include an inference engine 120 in the form of programmed logic executed by a processor at the profiling sever 118 to infer a user profile or an ad target profile from an input (e.g., incomplete) set of data points.

The profiling server 118 is in communication with a library 122 (e.g., database) of predetermined user profiles and a library 124 (e.g., database) of predetermined ad target profiles. Each ad and each user known to the system can be given a unique ad identifier or user identifier, respectively. The profiling server 118 can associate these identifiers with one or more of the predetermined ad target profiles or predetermined user profiles, respectively. That association can be stored in the libraries 122, 124.

According to one embodiment of the invention, the profiling server 118 can function to assist advertisers in choosing where to place ads, e.g., in choosing which ads to put forward to the ad exchange for an available ad slot (sometimes called an ad impression). For example, in one embodiment the ad exchange 110 can be arranged to run a real-time bidding (“RTB”) process to choose an ad to serve in response to an ad request. In this process, the ad exchange 110 can communicate details of an available ad impression to prospective participants (e.g., bidders) in the RTB process. The details of the ad impression can include, but are not limited to, a user identifier associated with the client device on which the ad impression is located.

The aim of the advertiser is to match an ad to the available ad impression that has the best chance of being effective, e.g., achieving an advertising goal or action. The processor at the profiling server 118 executes program code instructing the processor to provide a quantitative indication of the prospects of successfully achieving that aim. According to one embodiment, the quantitative indication is based on a comparison of the user profile associated with a user identifier (from the ad impression) and an ad target profile associated with an available ad from the advertiser. In one embodiment, the advertiser can use the quantitative indication to decide on a bid amount for an ad to be submitted into the RTB process.

The profiling server 118 can be a separate entity from an advertiser 112, whereby the advertisers never gain access to the detailed information in the user profiles or the ad target profiles, 124 and 122, respectively. In such an embodiment, program code executing at the profiling server 118 can instruct the processor to return a score that represents the quantitative indication upon receiving a user identifier and an ad identifier. Alternatively, if the advertiser sends a user identifier with a plurality of ad identifiers, the program code executing at the profiling server can instruct the processor to return a “best match” indication that tells the advertiser which ad is likely to be most successful for that user.

In another embodiment, a separate evaluation server (not shown) for running the evaluation engine can be provided for accessing user profiles and ad target profiles. The profiling server 118 can thus be reserved for the function of establishing and maintaining the associations between user identifiers and user profiles and ad identifiers and ad target profiles. The processor at the evaluation server can be in communication with the libraries 122, 124 in order to access and process the relevant profile information. The evaluation server can be an integrated part of an advertiser's functionality, e.g., the advertiser itself performs the comparison between the user profile and ad target profiles.

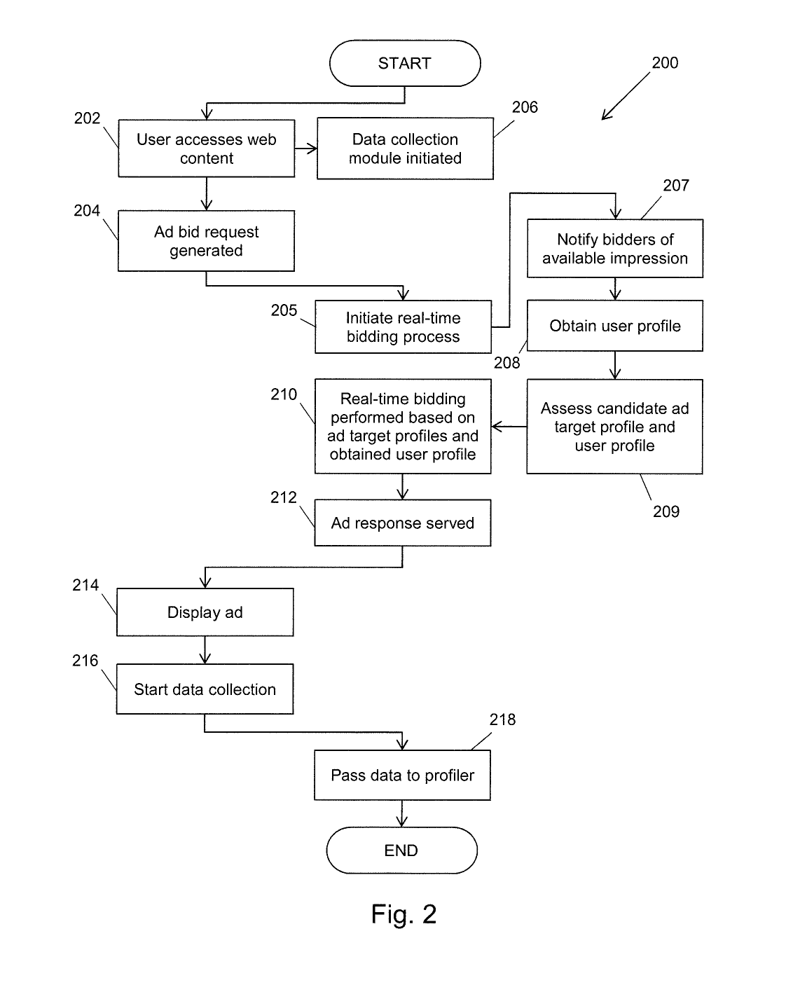

FIG. 2 is a flow chart that depicts a method 200 showing one embodiment of how the profile information can be collected and used. The method starts with a step 202 in which a user accesses web content on a client device (e.g., any of the client devices discussed above with reference to FIG. 1 or similar devices that are known to those of ordinary skill in the art).

Accessing web content in step 202 triggers a step 204 of generating an ad request and, if available, a step 206 of initiating a data collection module. The ad request can be an ad call transmitted to an ad exchange or the like, where it initiates an ad selection process, e.g., a real-time bidding process, to determine what ad should be served.

The data collection module can be an application stored on the client device that is arranged to instruct a processor therein to collect images using the webcam and other suitable information relating to the behaviour of the user. The collected images and other data are to be analysed to extract behavioural information about the user as he or she interacts with the web content. The data collection module is arranged to transmit information to a remote data collection server, where the results of the analysis are aggregated. The analysis can happen locally, e.g., on the client device, whereby partly or wholly analysed data is transmitted to the data collection server. Alternatively, the analysis can occur at the data collection server, whereby the information that is transmitted comprises the raw captured images or a video stream from the webcam.

Transmission of data to the remote server that has been analysed in whole or in part, in lieu of the raw captured image data, provides for an efficient data transfer from each local computer to the remote server, again resulting an improved usage of computational resources and a more minimized impact on the data upload from each individual local computer.

In some embodiments, the data collection module can not be initiated until the ad response is received. Accordingly, the code for initiating the data collection module, or a resource identifier enabling the client device to download or otherwise access the data collection module, can be part of the ad response that is served in response to the ad call.

According to the method of the present embodiment, the ad call includes a user identifier, e.g., a tracking pixel or the like, which is associated with a user profile (or a user profile metric, as discussed below). Upon receipt of the ad call in the ad exchange, the method continues with a step 205 of initiating a RTB process. The method continues with a step 207 of notifying prospective bidders of the existence of an available ad impression at the client device. The notification can be sent electronically from the ad exchange to one or more advertisers, or it can be managed by a demand side platform, as is conventional and well known to on of ordinary skill in the art. The notification includes the user identifier.

Upon receipt of the notification, a given advertiser must decide how to bid on the impression. This process can be automated, e.g., based on parameters relating to the ad impression itself and on the available ads. The process (automated or manual) can take into account behavioural information (and especially emotional state information) about both the user and a desired user target for an ad. This is achieved through a comparison of the user profile associated with the user identifier and an ad target profile associated with each available ad.

In the method of FIG. 2, upon notification of the available ad impression, a prospective bidder communicates the user identifier and one or more ad identifiers to a remote evaluating server. In the evaluating server, the method continues with a step 208 of obtaining the user profile or user profile metric associated with the user identifier and one or more candidate ad target profiles associated with the one or more ad identifiers. This step can be implemented as a call from the evaluating server to the user profile library 122 and ad target profile library 124, respectively, described above with reference to FIG. 1.

The method continues in the evaluating server with a step 209 of assessing (e.g., comparing) the candidate ad target profile(s) with the user profile to generate a quantitative indication (i.e., a score) that represents the quality of match between the ad target and the user. This is a valuable indicator of the prospects of an ad successfully achieving its goal, which has the direct result of improving network performance by preventing the transmission of unnecessary information. The processor at the evaluating server can return the quantitative indication to the prospective bidder as a parameter to be used in deciding how to bid on the available ad impression. The quantitative indication can be a score, or can be a recommended bid amount.

In addition to the quantitative indication based on the stored user profile and ad target profile, the prospective bidder can also be arranged to receive current behavioural data (e.g., current emotional state information) about the user that is captured at the client device and communicated in the ad request. This can provide a further parameter on which an advertiser can determine a bid.

The prospective bidder determines a bid based (at least in part) on the quantitative indication, and communicates that bid to the ad exchange. Upon obtaining the bid, the method continues in the ad exchange with a step 210 of selecting an ad to serve in response to the ad call by performing a real-time bidding process. When the real-time bidding process has concluded, the method continues with a step 212 of serving an ad response containing the winning ad back to the client device.

In one embodiment of the invention, the ads are video ads. The ad response can thus have an XML-based structure that is compatible with Video Ad Serving Template (“VAST”) 3.0 produced by the Interactive Advertising Bureau (“IAB”). The data collection module (or its resource identifier) can be provided in a creative element of the VAST response. An advantage of this arrangement is that it can ensure execution of the data collection module on any VAST compatible video player.

Upon receipt of the ad response, the method continues with a step 214 of displaying the ad on the client device and a step 216 of commencing behavioural data collection associated with that ad. As discussed above, the collected data can be wholly or partly analysed before sending to the data collecting server, such as whole or partial analysis at the client, where it is aggregated with data collected from other users who have consumed the same ad. The aggregated data thus gives global information about the reaction of users to a given ad.

In accordance with embodiments of the present invention, the analysed data from the data collecting module is also used to update or refine the particular user profile and/or the ad target profile. Thus, the method continues with a step 218 of passing the analysed data to a profiling server, where it is processed as discussed herein. The method thus provides a technique for periodically updating and refining a user profile as more behavioural data for that user becomes available. Similarly, as the number of impressions of a given ad increases, the aggregated data can be used to adapt or update the ad target profile.

By tying the ad display to user behavioural data, embodiments of the present invention minimize the need to unnecessarily transmit advertisements to uninterested users, thereby network usage and processor loads. Such savings can result in appreciable benefits, for example, when operating in a mobile environment such that battery life is prolonged and device performance is not adversely impacted by unnecessary receipt and processing of ads, as well as collection and possible processing of user behavioural data. Network operators also benefit by reducing or otherwise eliminating transmission loads caused by the transmission of unwanted or otherwise ineffective ads.

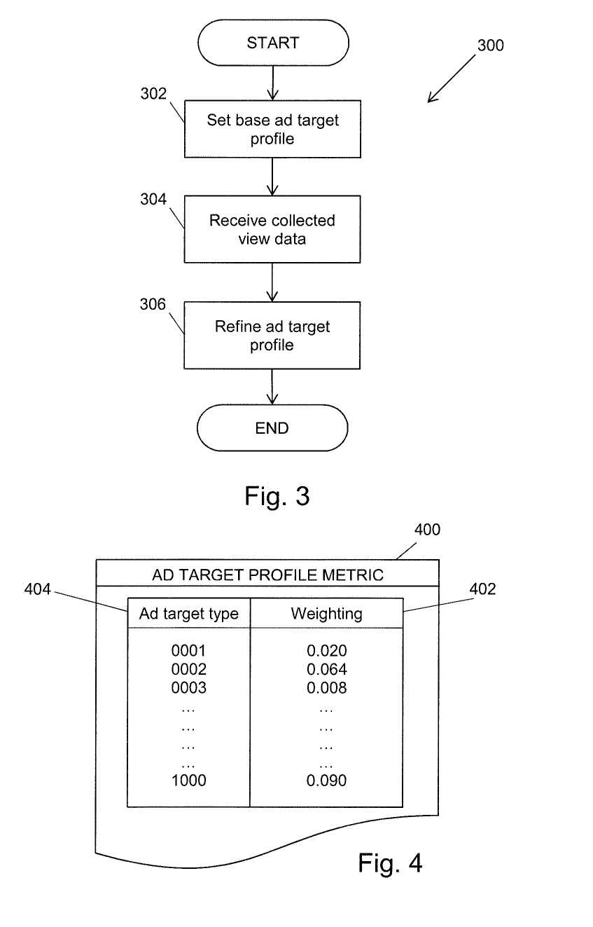

FIG. 3 is a flow chart depicting a method 300 of managing an ad target profile in accordance with one embodiment of the invention. The ad target profile is similar to the concept of a user profile. There can be a set of predetermined ad target types, wherein each ad target profile comprises a list of attributes that can be used to classify the ad, e.g., in terms of the properties of a desired consumer. These attributes can include information about the demographics of an audience that is more likely to respond favourably to the ad. Furthermore, the attributes can include information about the emotional profile of the ad, e.g., portions which are funny, sad, frightening, etc.

When an ad is made available by an advertiser, a profiling server can be notified. This notification can be made directly from the advertiser, or can occur at the stage where behavioural data is being collected from a user viewing the ad. The method in FIG. 3 begins in the profiling server with a step 302 of setting or assigning a base ad target profile. This means associating a unique ad identifier with a corresponding ad profile metric, which defines a relationship between the ad and one or more of a plurality of predetermined ad target profiles (referred to herein as ad target types). In a simple example, the unique ad identifier can be associated with a single predetermined ad target profile. However, in a more sophisticated embodiment, the user ad identifier is associated with an ad target profile metric 400 as shown in FIG. 4, which quantitatively associates the ad with each of a plurality of predetermined ad target types. For example, the ad target profile metric 400 can store a weighting value 402 against each ad target type 404 to represent the weight with which that ad is aimed at that predetermined ad type.

The step of setting the base ad target profile can be done by using previously collected audience behavioural data, e.g., data collected from a pre-release review panel. Alternatively, the base ad target profile can be inferred from properties of the ad itself, e.g., relating to content, style and expected emotional reaction (e.g., surprise in initial or final segment, humour in initial or final segment, etc.). In one embodiment, where no information is available about the ad, the weighting values stored in the ad profile metric for each ad type can be manually set.

After the ad is released and begins to be viewed, additional behavioural data and user data is collected. As the aggregated data in the data collecting server is updated, the method in FIG. 3 continues with a step 304 of receiving collected view data, e.g., information indicative of the aggregated data. The method continues with a step 306 of refining the ad target profile based on the received data. Refining the ad target profile can refer to changing the predetermined ad target profile with which the unique ad identifier is associated based on the additional information received. Alternatively, in in conjunction with the foregoing, refining the ad target profile based on the received data can refer to updating the weighting values in the ad target profile metric.

FIG. 4 shows one embodiment of a schematic view of an ad target profile metric 400. The ad target profile metric for any given ad can be stored in the library 124 in association with a unique identifier for that ad. The ad target profile metric stores a weighting value 402 against each of the plurality of predetermined ad target types 404. The metric thus indicates the weighting, e.g., emphasis or level of targeting, that the associated ad is given towards a certain ad target type. As more information is gathered about the ad, the weighting values are refined.

FIG. 5 is a flow chart depicting a method 500 of managing a user profile according to one embodiment of the invention. The management process can be performed by the profiling server discussed above with reference to FIG. 1. The method begins with a step 502 of setting a base user profile to be associated with a unique user identifier. The base user profile can be inferred from historical data 504 relating to the user, e.g., previous ad views, browsing history, demographic information, etc.

Similarly to the ad target profiles discussed above, the system can have a set of predetermined user profiles (referred to herein as user types). A given user can be associated with a unique user identifier, which in turn is matched with one or more of the predetermined user types. FIG. 6 shows a schematic view of a probability metric 600 that can be stored for a given unique user identifier. The probability metric stores a probability 602 against each of the plurality of predetermined user types 604. As behavioural data is collected for the user in response to live ad views, the method continues with a step 506 of receiving the results of the analysis from the data collecting server and a step 508 of refining or updating the user profile based on this information.

The methods and system outlined above provide a way of introducing behavioural data, and in particular emotion state information about users, into a scheme for selecting ad to be displayed. By providing information about a user's behaviour (e.g., engagement or attentiveness) and emotional state, embodiments of the invention give the profiling another dimension and thus enables matching of users to appropriate ads to be performed more accurately.

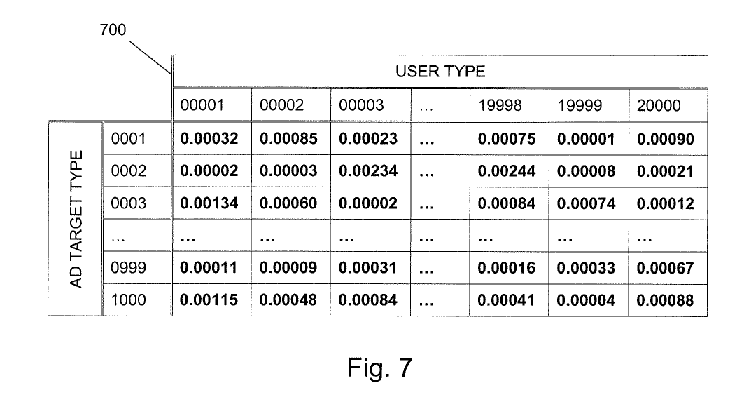

Thus for a given user type, there can be a parameter that quantifies the probability of achieving a desired action in respect of a given ad type. As further information about users who share a given user profile is collected, the probabilities associated with each ad type can be refined. FIG. 7 shows an example of an action probability matrix in which an action probability is stored for each combination of a preset ad target type and a preset user type. The matrix can be stored and/or maintained in either the ad exchange or in the profiling server. For example, if information indicative of an ad resulting in a successful action is received, the values in the user profile metric and ad target profile metric used in generating the successful action can be used to update or refine the matrix.

The matrix 700 can be used in a real time bidding process to generate a quantitative indication of the level of match between an ad and a user. By representing the ad target profile metric as a row vector and the user profile metric as a column vector the matrix 700, which may be implemented as a data structure and stored in a memory device for retrieval by a processor, can be used to generate a value corresponding to the sum of the product of weighting value, action probability and user probability for each combination of ad type and user type. The higher this number, the better the match between the user and ad.

FIGS. 1 through 7 are conceptual illustrations allowing for an explanation of the embodiments of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more hardware processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their

1. A computer-implemented method of participating in a web-based ad bidding process, the method comprising:
receiving notification of an ad impression, the notification including a user identifier associated with a user of a remote client device on which the ad impression is located;
selecting a candidate ad for the ad impression;
sending the user identifier and an ad identifier associated with the candidate ad to an evaluation engine;
obtaining a user profile associated with the user identifier and indicative of the user's behavioural characteristics;
obtaining an ad target profile associated with the ad identifier and indicative of a target user's desired behavioural characteristics;
comparing the user profile with the ad target profile to generate a quantitative indicator of the similarity between the user profile and the ad target profile;
returning the quantitative indicator to the ad network; and
determining, based on the quantitative indicator, a bid for the candidate ad in response to the ad impression.

2. A method according to claim 1 comprising:
receiving, in an ad exchange, a plurality of bids for candidate ads in response to the ad impression;
determining, in the ad exchange, a successful bid from the plurality of bids; and
serving advertising content corresponding to the successful bid over the web to the remote client device in satisfaction of the ad impression.

3. A method according to claim 1, wherein comparing the user profile with the ad target profile comprises determining a level of correlation between the user's behavioural characteristics and the target user's desired behavioural characteristics, and wherein the quantitative indicator is based on the determined level of correlation.

4. A method according to claim 1, comprising associating the user, through use of user profile, with one or more of a plurality of preset user types, wherein each preset user type includes a predetermined combination of behavioural characteristics.

5. A method according to claim 4, comprising storing in the user profile, a user profile metric that maintains a user probability value for the user against each of the plurality of preset user types.

6. A method according to claim 1, comprising associating the ad with one or more of a plurality of preset ad target types through use of the ad target profile, wherein each preset ad target type includes a predetermined combination of behavioural characteristics.

7. A method according to claim 6, comprising storing in the ad target profile an ad target profile metric that maintains an ad probability value for the ad against each of the plurality of preset ad target types.

8. A method according to claim 7 comprising:
generating a user-target correlation matrix, which is a data structure that stores a correlation index value against each combination of a preset user type from the plurality of preset user types and a preset ad target type from the plurality of present ad target types;
calculating a correlation index for each combination of a preset user type from the plurality of preset user types and a preset ad target type from the plurality of present ad target types using the ad probability value, user probability value and an action probability index value for that combination; and
basing the quantitative indicator on the calculated correlation indices,
wherein the action probability index value is a parameter that quantifies the probability of achieving a desired action in respect of a given preset ad target type for a given preset user type.

9. A method according to claim 8, calculating a product of the probability value, action probability index value and weighting value for each combination of a preset user type from the plurality of preset user types and a preset ad target type from the plurality of present ad target types in the correlation index.

10. (canceled)

11. A method according to claim 2, wherein the step of determining, in the ad exchange, a successful bid from the plurality of bids occurs as part of a real-time bidding process.

12. A method according to claim 2 comprising:
displaying the advertising content corresponding to the successful bid on the client device in response to the ad request; and
collecting behavioural data of the user from the client device while the user is viewing the advertising content.

13. A method according to claim 12 comprising refining the user profile based on the collected behavioural data.

14. A method according to claim 13, comprising associating the user, through use of the user profile, the user with one or more of a plurality of preset user types, wherein each preset user type includes a predetermined combination of behavioural characteristics, and wherein the step of refining the user profile comprises altering the one or more of the plurality of preset user types that are associated with the user.

15. A method according to claim 14, wherein step of refining the user profile comprises deploying and executing one or more unsupervised machine learning processes.

16. A method according to claim 13, comprising storing, in the user profile, a user profile metric that stores a probability value for the user against each of a plurality of preset user types, wherein each preset user type includes a predetermined combination of behavioural characteristics, and wherein the step of refining the user profile comprises adjusting one or more of the probability values.

17. A method according to claim 13, comprising inferring behavioural characteristics of the user from the collected behavioural data, wherein the step of refining the user profile comprises using the behavioural characteristics obtained from the inferring step.

18. A method according to claim 12 comprising refining an ad target profile associated with the advertising content based on the collected behavioural data.

19. A method according to claim 18, comprising associating the advertising content with one or more of a plurality of preset ad target types through use of the ad target profile, wherein a given preset ad target type comprises a predetermined combination of behavioural characteristics, and wherein the step of refining the ad target profile comprises altering the one or more of the plurality of preset ad target types that are associated with the advertising content.

20. A method according to claim 19, wherein step of refining the ad target profile comprises deploying and executing one or more unsupervised machine learning processes.

21. A method according to claim 18, comprising storing in the ad target profile an ad target profile metric that maintains a weighting value for the advertising content against each of a plurality of preset ad target types, wherein each preset ad target type comprises a predetermined combination of behavioural characteristics, and wherein the step of refining the ad target profile comprises adjusting one or more of the weighting values.

22. A method according to claim 19, wherein the step of refining the ad target profile comprises aggregating behavioural data collected from a plurality of users.

23. (canceled)

24. A method according to claim 1, wherein determining the user's behavioural characteristics comprises collecting emotional state information representing average properties for one or more emotions collected from the user.

25. A method according to claim 1, wherein determining the user's behavioural characteristics comprises collecting emotional state information representing average properties for one or more emotions in aggregated behavioural data collected from a plurality of users.

26. A method according to claim 1, wherein collecting emotional state information comprises emotional state information selected from the group consisting of: angry, disgusted, neutral, sad, scared, happy, surprised and their derivatives.

27. A computer-implemented method of selecting a web-based ad, the method comprising:
receiving notification of an ad impression, the notification including a user identifier associated with a user of a remote client device on which the ad impression is located;
selecting a plurality of candidate ads for the ad impression;
sending the user identifier and an ad identifier associated with each of the plurality of candidate ads to an evaluation engine;
obtaining a user profile associated with the user identifier;
obtaining an ad target profile associated with each ad identifier;
comparing the user profile with each ad target profile to generate a plurality of quantitative indicators of the similarity between the user profile and each ad target profile;
selecting, based on the quantitative indicator, an ad from the plurality of candidate ads to serve in response to the ad impression; and
serving the selected ad to the remote client device on which the ad impression is located.

28. (canceled)
